(19) United States
(12) Patent Application Publication
(10) Pub. No.: US 2008/0036440 A1
(43) Pub. Date: Feb. 14, 2008

(54) Systems and Methods for Providing Maximum Photovoltaic Peak Power Tracking

(75) Inventor: William Garmer, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignee: AMBIENT CONTROL SYSTEMS, INC., El Cajon, CA (US)

(21) Appl. No.: 11/630,186

(22) PCT Filed: Jun. 24, 2005
(86) PCT No.: PCT/US05/22509

§ 371 Date: Dec. 20, 2006

Related U.S. Application Data
(60) Provisional application No. 60/582,075, filed on Jun. 24, 2004.

(51) Int. Cl. G05F 5/00

(52) U.S. Cl. 323/299

(57) ABSTRACT

A micropower Maximum Power Point Tracker (μMPPT) suitable for use in low power applications to maximize the power output for a solar-power cell array. In one embodiment, a μMPPT comprises an electrical circuit which includes a microprocessor/microcontroller used to execute the μMPPT control algorithm, and a modulator controller to control the pulse width or frequency to a high speed switch. In addition, the electrical circuit may include an analog-to-digital (A/D) converter usable to measure the input voltage from a connected solar array, the current through an inductor of the circuit, and the voltage of an attached energy store/load. In another embodiment, the μMPPT may operates in at least two modes depending on the energy store/loads conditions.

### CROSS REFERENCE TO RELATED APPLICATION

This application is related to and claims priority from the U.S. provisional patent application having application No. 60/582,075, filed on Jun. 24, 2004, and is the National Stage of International Application No. PCT/US2005/022509, filed Jun. 24, 2005.

### 1. FIELD OF THE INVENTION

The invention relates in general to power management, and in particular to a maximum power point tracker circuit used to improve photovoltaic module efficiency in solar-powered applications.

### 2. BACKGROUND

Certain solar-powered systems, such as remote instrumentation packages, operate at relatively low power levels. In order to maximize the amount of power generated by photovoltaic modules, typical solar-powered systems have made use of a Maximum Power Point Tracker (MPPT). Currently available MPPT can be either electromechanical tracking system that point the solar array at the sun, and electronic controller system that adjust the apparent load on the solar array such that it operates at its maximum output power. However, electromechanical systems have not been appropriate for low power solar arrays or small installations. Electronic systems, on the other hand, are neither efficient nor cost effective at relatively low power levels (e.g., below 300 Watts). Thus, what is needed is an electronic MPPT based on low power microprocessor/microcontroller technology suitable for smaller solar arrays.

### BRIEF SUMMARY OF THE INVENTION

Disclosed and claimed herein are systems and methods for providing maximum photovoltaic peak power tracking. In one embodiment, a method includes executing a power control algorithm, providing a switching frequency or pulse width based on the power control algorithm to a high speed switching circuit, and measuring one of an voltage output or a power output of a solar array. The method further includes determining a maximum power point of the solar array using one of the voltage output and said power output, and adjusting the switching frequency or pulse width to match the maximum power point of the solar array.

Other aspects, features, and techniques of the invention will be apparent to one skilled in the relevant art in view of the following detailed description of the invention.

### BRIEF DESCRIPTION OF DRAWINGS

FIG. 1 is a graph of depicts a graph of the output voltage versus current for a typical triple-junction solar cell;

FIG. 2 is a simplified diagram of a system in which one embodiment of the invention may be implemented;

FIG. 3 is a schematic diagram of an electrical circuit capable of carrying out one or more aspects of one embodiment of the invention; and

FIG. 4 is a schematic diagram of another electrical circuit capable of carrying out one or more aspects of another embodiment of the invention.

### DETAILED DESCRIPTION OF THE PREFERRED EMBODIMENT

One aspect of the invention is to increase the available power for low-power, remote equipment or equipment that is required to operate without external power connections. In one embodiment, a micropower Maximum Power Point Tracker (μMPPT) suitable for use in low power applications is used to maximize the power output for a solar-power cell array.

In one embodiment, a μMPPT comprises an electrical circuit which includes a microprocessor/microcontroller used to execute the μMPPT control algorithm, and a modulator controller to control the pulse width or frequency to a high speed switch, such as a metal-oxide semiconductor field-effect transistor (MOSFET). In addition, the electrical circuit may include an analog-to-digital (A/D) converter, either external to or as part of the microprocessor/microcontroller, usable to measure the input voltage from a connected solar array, the current through an inductor of the circuit, and the voltage of an attached energy store or load.

Another aspect of the invention is a μMPPT that operates in at least two modes. In one embodiment, the first mode occurs when the energy store is fully charged or the power requirements of the load is less than the maximum available power from the solar array. In this mode, the μMPPT switches into a voltage regulation mode of operation in which the μMPPT acts as a DC-DC voltage converter holding the output voltage to the energy store or load at a pre-programmed maximum voltage

The second mode of operation for the μMPPT occurs when a connected energy store or load can draw more power than the solar array is able to produce. In this first mode, the μMPPT isolates the energy store or load by presenting an effective impedance to the solar array that matches it maximum power output. In another embodiment, the μMPPT may also dynamically dither this impedance to track the maximum power point over variations in temperature, light conditions, etc.

Another aspect of the invention is to measure the power delivered by a solar array, as opposed to measuring the voltage and adjusting the effective load so that the voltage remains at the maximum power point. This may be desirable for applications involving multiple junction cells where different cells work on different parts of the solar spectrum. In some cases, the maximum power point may not be at the normal voltage. For example, some cells are designed to work on the infrared region of the spectrum. On cloudy days, this portion of the spectrum may be significantly reduced, thereby causing the maximum power point voltage to be reduced. To that end, in one embodiment a control loop executed by a microprocessor/microcontroller can be used to detect this effect and adjust accordingly.

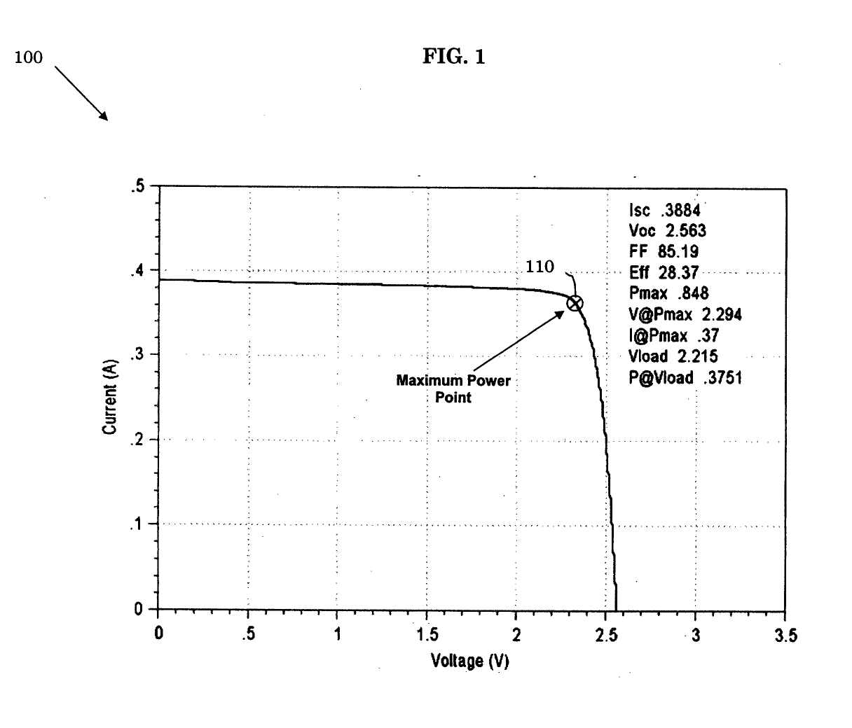

The amount of power that can be generated by a photovoltaic (PV) cell array is dependent on such factors as the ambient light level, ambient temperature, the area of the array, etc. In many cases, the available surface area for mounting PV cells is limited by operational requirements of that equipment. Thus, it is desirable to extract the maximum amount of available power from the array in an efficient manner. To that end, FIG. 1 depicts a graph 100 of the output voltage versus current for a typical triple-junction solar cell. In particular, graph 100 illustrates that the maximum power output is achieved when a load is matched to the maximum power point 110 of the solar cell.

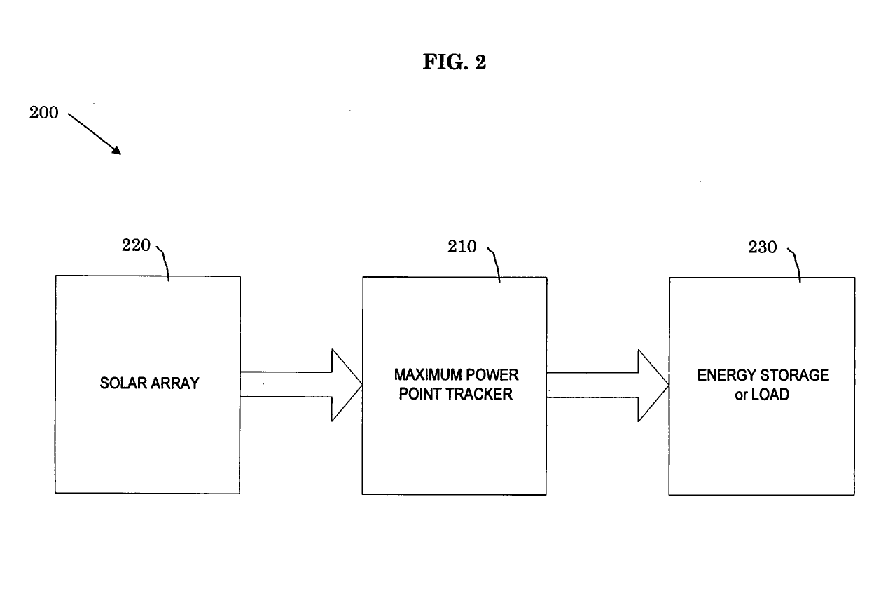

Referring now to FIG. 2, depicted is one embodiment of a system 200 in which a μMPPT 210 is located between an array of solar cells 220 and an energy store/load subsystem 230. In one embodiment, the energy store/load subsystem 230 may be based on capacitor technology, although any energy storage technology or energy load capable of being connected to a solar-power array may similarly be used.

As previously mentioned, μMPPT 210 may operate in at least two modes depending on the condition of the attached energy store/load subsystem 230. The first mode occurs when the energy subsystem 230 is at full charge, in the case where the subsystem is an energy store, or, in the case where the subsystem is an energy load, more power than can be provided by the solar array 220 is not being drawn. In this mode, the μMPPT 210 operates as a DC-DC controller in which the duty cycle or frequency of a modulator controller (e.g., pulse width modulator) is dynamically adjusted to maintain the output voltage at the full charge level (i.e. constant output voltage level).

The second mode occurs when the subsystem 230 is at less than full charge, in the case where the subsystem is an energy store, or, in the case where the subsystem is an energy load, more power is being drawn than can be provided by the solar array 220. In this mode, the μMPPT 210 isolates the subsystem 230 by presenting an effective impedance to the solar array that matches it maximum power output. The duty cycle or frequency of the modulator controller may then be dynamically adjusted to maintain the maximum output power draw from the solar array.

The maximum power point may be measured in at least two ways. The first is to adjust the duty cycle based on the maximum power point voltage of the solar array. This approach may be preferable for single-junction solar arrays in an area with only moderate temperature variations. The second way to measure the maximum power point is by measuring the peak current through an inductor of the μMPPT 210. In this case, the control algorithm of the μMPPT 210 adjusts the duty cycle or frequency based on the measured output power from the solar array until the peak power is found. In one embodiment, the power level may be continuously monitored to maintain the optimum duty cycle/frequency. This approach may be preferable for applications using multiple-junction solar arrays and/or arrays located in areas where large temperature variations can be expected.

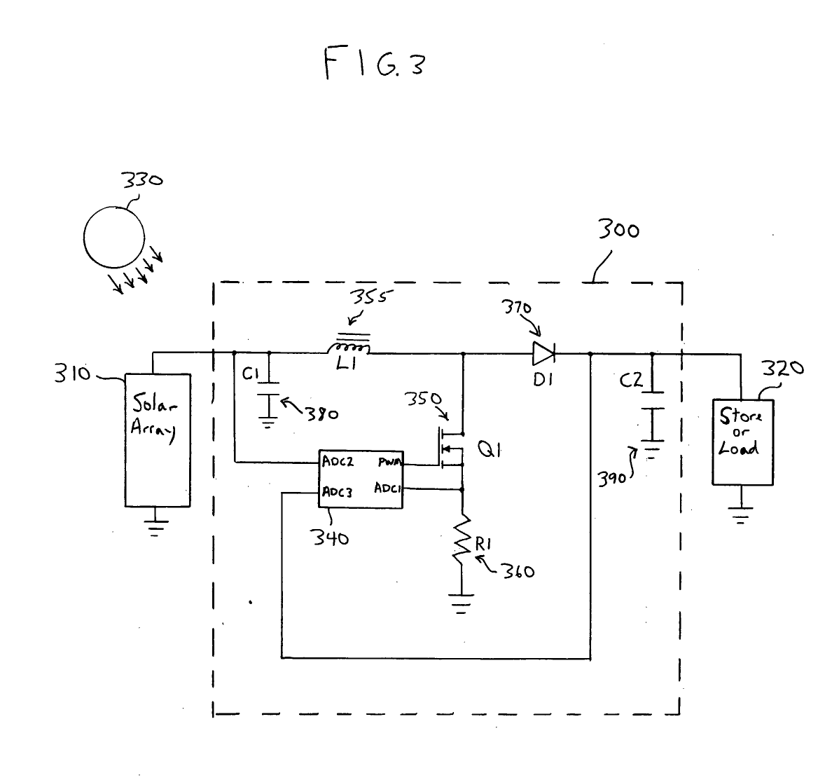

With reference now to FIG. 3, depicted is one embodiment of an electrical circuit 300 having a boost mode DC-DC converter topology in which the circuit 300 connects a solar array 310 to an energy store or load subsystem 320. However, it should equally be appreciated any DC-DC converter topology may be used with any power source that requires a specific output impedance to deliver the maximum amount of power. For example, the microprocessor/microcontroller 340 may be programmed to execute the necessary charging algorithm based on the particular battery chemistry used. In one embodiment, the microprocessor/microcontroller 340 may be programmed at the factory level for the particular power source application.

The solar array 310 generates electrical power from solar energy source 330, which may be any source capable of providing solar radiation energy. In this embodiment, a microprocessor/microcontroller 340 uses a PWM output generated by either a software controller output port or an on-chip peripheral to control a switching transistor 350 (Q1). Although depicted internally, it should be appreciated that the PWM controller may be external to the microprocessor/microcontroller 340.

The microprocessor/microcontroller 340 may be used to measure the current through the inductor 355 (L1) when the switching transistor 350 (Q1) (which in one embodiment is a MOSFET) is turned on by measuring the voltage across resistor 360 (R1). Once the voltage across resistor 360 (R1) is known, the amount of power being delivered to the energy store or load system 320 can be computed by the microprocessor/microcontroller 340. By adjusting either the switching frequency or pulse width provided to the switching transistor 350 (Q1), the microprocessor/microcontroller 340 can vary the power drawn from the solar array 310 to match the maximum power point of the solar array 310. The electrical circuit 300 if FIG. 3 also includes a blocking diode 370 (D1) that prevents current from being drawn from the subsystem 320 back into the circuit 300. In addition, capacitors 380 (C1) and 390 (C2) may be used to filter current ripples potentially generated by the switching action of the circuit 300. Although depicted using the inductor 355 (L1) current to measure input power, it should be appreciated that by measuring the input voltage and current of the solar array 310, power from the solar array 310 can be computed.

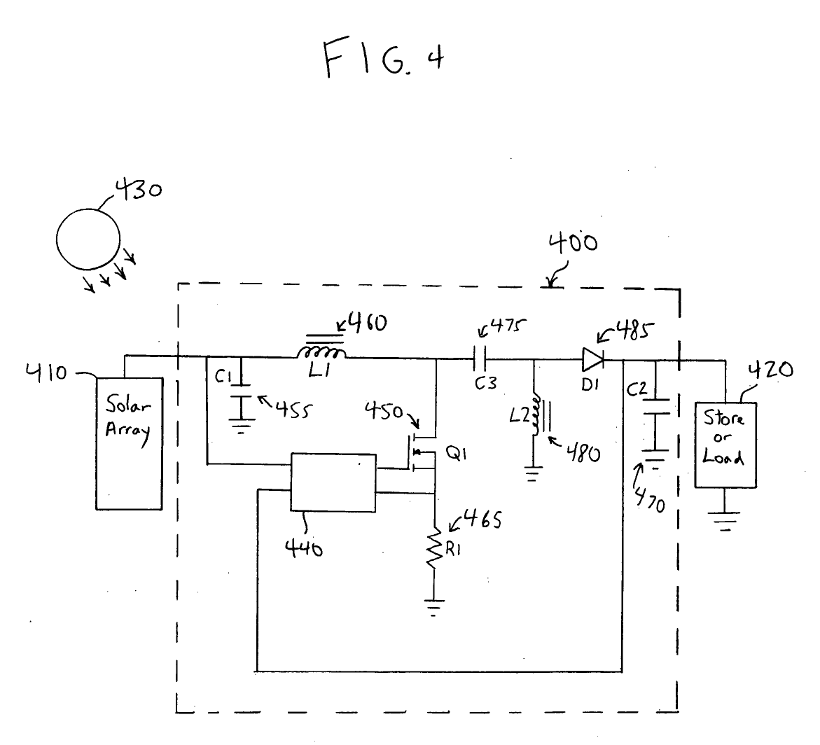

FIG. 4 depicts one embodiment of an electrical circuit 400 using a SEPIC mode DC-DC converter topology. This topology allows the output voltage to be either higher or lower than the input voltage. This topology may be preferable where the maximum power point of the solar array varies over an extremely wide range.

As with the previously-described circuit 300 of FIG. 3, circuit 400 connects a solar array 410 to an energy store or load subsystem 420. The solar array 410 generates electrical power from solar energy source 430, which may be any source capable of providing solar radiation energy. In this embodiment, a microprocessor/microcontroller 440 uses a PWM output (not shown) generated by either a software controller output port or an on-chip peripheral to control a switching transistor 450. It should be appreciated that the PWM controller may be internal or external to the microprocessor/microcontroller 440.

Circuit 400 operates in a similar manner as circuit 300 of FIG. 3, with only a few differences. In particular, circuit 400 uses a SEPIC (Single Ended Primary Inductor Circuit) DC-DC converter topology to convert the energy from the solar array 410 to energy subsystem 420. In one embodiment, capacity 455 (C1) filters the current pulse generated by the circuit 400 from the solar array 410. When the switching transistor 450 (Q1) is turned on, current may flow through inductor 460 (L1) storing energy within its magnetic field. Microprocessor/microcontroller 440 can then measure the current in inductor 460 (L1) by measuring the voltage drop across resistor 465 (R1). This may allow the microprocessor/microcontroller 440 to compute the amount of energy being drawn from the solar array 410. While the switching transistor 450 (Q1) is turned on, the power to the energy subsystem 420 may be maintained by the capacitor 470 (C2). When switching transistor 450 (Q1) is turned off, on the other hand, the energy stored in inductor 460 (L1) may be used to charge capacitor 475 (C3), inductor 480 (L2), and capacitor 470 (C2). Diode 485 (D1) may be used to prevent energy in capacitor 470 (C2) from flowing back into inductor 480 (L2). One potential advantage of the configuration of circuit 400 is the ability to handle input voltages from the solar array 410 that are either above or below the actual voltage delivered to the energy subsystem 420.

In one embodiment, the microprocessor/microcontroller 440 may determine the maximum output power point for the solar array 410 by dithering either the pulse width or frequency and measuring the output power. In one embodiment, the pulse width or frequency is changed in small steps above and below a center point. The power delivered may then be measured for each step. The step that delivered the highest power may then be used as the new center point, after which the process may be repeated. In one embodiment, the maximum power point is reached when the current center point (either pulse width or frequency) delivers the highest power and the steps on either side deliver less power.

The maximum power point can also be measured by the microprocessor/microcontroller 440 by stopping all switching action and measuring the open circuit voltage from of the solar array 410. In one embodiment, the open-circuit voltage of the solar array 410 can be measured by stopping the power switch 450. This takes the load of the energy subsystem 420 off of the solar array 410. The voltage may then be measured using an analog-to-digital converter (which may be either internal or external to the microprocessor/microcontroller 440). The maximum power point voltage is a fraction of the open-circuit voltage determined by the type of solar cells used in the construction of the array. Once found, circuit 400 can operation such that the output voltage of the solar array 410 is maintained at that level.

In another embodiment, an onboard controller (e.g., microprocessor/microcontroller 340 or 440) can be used to communicate the status of the μMPPT, solar array and/or energy store/load to a separate system (or user), which in one embodiment may be powered by the solar array itself. This may be useful to enable such system to operate in various power states depending on the available power. For example, if the light level is low, the separate system may operate at a lower power mode to minimize the energy draw. In higher light conditions, the separate system may perform more duties or schedule higher power requirement tasks. While in one embodiment, this status information may be transmitted to one or more separate systems (or users) via any known communication line interface (such as RS-232, USB, etc), it may equally be communicated wirelessly using any known protocol.

While the preceding description has been directed to particular embodiments, it is understood that those skilled in the art may conceive modifications and/or variations to the specific embodiments described herein. Any such modifications or variations which fall within the purview of this description are intended to be included herein as well. It is understood that the description herein is intended to be illustrative only and is not intended to limit the scope of the invention.

In all embodiments, the μMPPT microprocessor/microcontroller (340/440) can also measure an energy storage medium, such as batteries, capacitors, etc. by executing the necessary charging algorithm based on the particular energy storage medium chemistry, eliminating the need for a separate charge controller. Further refinements to the energy storage medium can be compensated for by the μMPPT microprocessor/microcontroller (340/440). One such refinement would be in an energy storage medium consisting of capacitors where adjusting the final charge voltage based on temperature would maximize the capacitors service life. This embodiment would reduce system complexity and increase system reliability.

1. A circuit coupled to a solar array and to an energy subsystem, the circuit comprising:
a processor for executing a power control algorithm;
a modulation controller controlled by said processor, said modulation controller to provide a switching frequency or pulse width to a high speed switching circuit in accordance with said power control algorithm; and
an analog-to-digital converter for measuring a voltage of the solar array,
wherein said processor is to determine the maximum power point of the solar array using said measured voltage of the solar array, to adjust the switching frequency or pulse width of said modulation controller to match the maximum power point of said solar array and to cause said circuit to operate in at least a first mode and a second mode depending on a state of said energy subsystem.

2. The circuit of claim 1, wherein said circuit is a micropower maximum power point tracker usable in a low power application.

3. The circuit of claim 1, wherein said modulation controller is a pulse width modulator, and said high speed switching circuit is a metal-oxide semiconductor field-effect transistor.

4. The circuit of claim 1, wherein said energy subsystem is one of an energy store and an energy load.

5. (canceled)

6. The circuit of claim 1, where said processor causes the circuit to operate in the first mode when the energy subsystem draws less power than said solar array can provide, and wherein said processor causes the circuit to operate in the second mode when the energy subsystem draws more power than said solar array can provide.

7. The circuit of claim 6, wherein said circuit functions as a DC-DC controller while in said first mode by dynamically adjusting said switching frequency or pulse width of said modulation controller to maintain a constant output voltage.

8. The circuit of claim 6, wherein said circuit presents an effective impedance to said solar array that matches said maximum power point while in said second mode, and wherein said switching frequency or pulse width of said modulation controller is dynamically adjusted to maintain a maximum power output from said solar array.

9. A method of controlling power provided by a solar array to an energy subsystem, the method comprising:
executing a power control algorithm;
providing a switching frequency or pulse width based on said power control algorithm to a high speed switching circuit;
measuring one of an voltage output or a power output of said solar array; and
determining a maximum power point of the solar array using one of said voltage output and said power output;
adjusting said switching frequency or pulse width to match said maximum power point of said solar array;
determining a state of said energy subsystem; and
operating in at least one of a first mode and a second mode based on said state.

10. The method of claim 9, wherein providing the switching frequency or pulse width comprises providing said switching frequency or pulse width by pulse width modulator to a metal-oxide semiconductor field-effect transistor.

11. The method of claim 9, wherein said energy subsystem is one of an energy store and an energy load.

12. (canceled)

13. The method of claim 9, wherein operating in at least one of the first mode and the second mode comprises operating in said first mode when the energy subsystem draws less power than said solar array can provide, and operating in said second mode when the energy subsystem draws more power than said solar array can provide.

14. The method of claim 13, further comprising adjusting dynamically, when operating in said first mode, the switching frequency or pulse width of said modulation controller to maintain a constant output voltage.

15. The method of claim 13, further comprising:
presenting an effective impedance to said solar array that matches said maximum power point while in said second mode; and
adjusting dynamically said switching frequency or pulse width to maintain a maximum power output from said solar array.

16. A circuit coupled to a solar array and to an energy subsystem, the circuit comprising:
a processor for executing a power control algorithm; and
a modulation controller controlled by said processor, said modulation controller to provide a switching frequency or pulse width to a high speed switching circuit in accordance with said power control algorithm, wherein said processor is to determine the maximum power point of the solar array by measuring the power delivered by the solar array to the energy subsystem, to adjust the switching frequency or pulse width of said modulation controller to match the maximum power point of said solar array and to cause said circuit to operate in at least a first mode and a second mode depending on a state of said energy subsystem.

17. The circuit of claim 16, wherein said circuit is a micropower maximum power point tracker usable in a low power application.

18. The circuit of claim 16, wherein said modulation controller is a pulse width modulator, and said high speed switching circuit is a metal-oxide semiconductor field-effect transistor.

19. The circuit of claim 16, wherein said energy subsystem is one of an energy store and an energy load.

20. (canceled)

21. The circuit of claim 16, where said processor causes the circuit to operate in the first mode when the energy subsystem draws less power than said solar array can provide, and wherein said processor causes the circuit to operate in the second mode when the energy subsystem draws more power than said solar array can provide.

22. The circuit of claim 21, wherein said circuit functions as a DC-DC controller while in said first mode by dynamically adjusting said switching frequency or pulse width of said modulation controller to maintain a constant output voltage.

23. The circuit of claim 21, wherein said circuit presents an effective impedance to said solar array that matches said maximum power point while in said second mode, and wherein said switching frequency or pulse width of said modulation controller is dynamically adjusted to maintain a maximum power output from said solar array.

24. The circuit of claim 1, wherein said processor executes said charging algorithm based on said energy subsystem technology, without the need of an additional charge controller.

25. A circuit coupled to a solar array and to an energy subsystem, the circuit comprising:
a processor for executing a power control algorithm;
a modulation controller controlled by said processor, said modulation controller to provide a switching frequency or pulse width to a high speed switching circuit in accordance with said power control algorithm;
an inductor electrically connected to the solar array; and
an analog-to-digital converter for measuring one of (i) a voltage and a current of the solar array, or (ii) a current of the inductor and a voltage at the energy subsystem,
wherein said processor is to determine the maximum power point of the solar array using one of said measured voltage and current of the solar array or said measured current of the inductor, and to adjust the switching frequency or pulse width of said modulation controller to match the maximum power point of said solar array.

26. The circuit of claim 25, wherein said circuit is a micropower maximum power point tracker usable in a low power application.

27. The circuit of claim 25, wherein said modulation controller is a pulse width modulator, and said high speed switching circuit is a metal-oxide semiconductor field-effect transistor.

28. The circuit of claim 25, wherein said energy subsystem is one of an energy store and an energy load.

29. The circuit of claim 25, wherein said processor causes said circuit to operate in at least a first mode and a second mode depending on a state of said energy subsystem.

30. The circuit of claim 29, where said processor causes the circuit to operate in the first mode when the energy subsystem draws less power than said solar array can provide, and wherein said processor causes the circuit to operate in the second mode when the energy subsystem draws more power than said solar array can provide.

31. The circuit of claim 29, wherein said circuit functions as a DC-DC controller while in said first mode by dynamically adjusting said switching frequency or pulse width of said modulation controller to maintain a constant output voltage.

32. The circuit of claim 29, wherein said circuit presents an effective impedance to said solar array that matches said maximum power point while in said second mode, and wherein said switching frequency or pulse width of said modulation controller is dynamically adjusted to maintain a maximum power output from said solar array.
